(19) United States
(12) Patent Application Publication
(10) Pub. No.: US 2023/0147761 A1
(43) Pub. Date: May 11, 2023

(54) AQUEOUS SOLUTION AND REPAIR METHOD

(71) Applicant: NIPPON TELEGRAPH AND TELEPHONE CORPORATION, Tokyo (JP)

(72) Inventors: Yosuke TAKEUCHI, Tokyo (JP); Junichiro TAMAMATSU, Tokyo (JP); Yosuke OKAMURA, Tokyo (JP); Hisatoshi KASAHARA, Tokyo (JP)

(73) Assignee: NIPPON TELEGRAPH AND TELEPHONE CORPORATION, Tokyo (JP)

(21) Appl. No.: 17/913,148

(22) PCT Filed: Mar. 25, 2020
(86) PCT No.: PCT/JP2020/013420

§ 371 Date: Sep. 20, 2022

(51) Int. Cl. C23F 11/18

(52) U.S. Cl. CPC C23F 11/182

(57) ABSTRACT

An aqueous solution (20) is an aqueous solution used for repairing an aluminum-coated steel wire (10) with defects leading to there being iron, which contains magnesium chloride having a concentration of 10% or more, and magnesium sulfate having a concentration of 6% or more, and which allows an anticorrosion layer made of an alloy component of magnesium and aluminum to be formed.

### TECHNICAL FIELD

The present invention relates to an aqueous solution and a repair method.

### BACKGROUND ART

Aluminum coating is one method of protecting iron from corrosion. When aluminum is exposed to an atmospheric environment, a dense barrier layer composed of an amorphous aluminum oxide and a coarse porous layer composed of an aluminum oxide hydrate are formed (for example, refer to Non Patent Literature 1). Since the barrier layer has a very low corrosion rate, it is possible to provide high corrosion resistance by coating iron with aluminum.

In this manner, an aluminum-coated steel wire has high corrosion resistance, but when defects occur due to external damage or the like, there is a risk of corrosion of elemental iron and galvanic corrosion of dissimilar metals of aluminum and iron progressing. Therefore, when defects leading to there being iron are expected to occur, a proactive measure may be performed to apply an anticorrosion coating such as a resin coating or a sacrificial clad on the aluminum coating in advance. In addition, after defects leading to there being iron occur, a repair method in which a corrosion product (for example, rust) is removed and anticorrosion coating is then performed in consideration of concerns such as corrosion under a coating film or problems of adhesion with a coating material may be used.

### CITATION LIST

### Non Patent Literature

[NPL 1] Oya and two others, “The Fundamentals of the Aluminum Corrosion-Relationship between the Oxide Film and the Corrosion”, UACJ Technical Reports, vol. 3, pp. 52-56, 2016

### SUMMARY OF THE INVENTION

### Technical Problem

However, as described above, in order to repair an aluminum-coated steel wire with defects leading to there being iron, it is essential to remove the corrosion products, and thus there are problems such as complexity and high cost.

In view of such circumstances, an object of the present invention is to provide an aqueous solution and a repair method through which it is possible to easily repair an aluminum-coated steel wire with defects leading to there being iron at low cost.

### Means for Solving the Problem

In order to address the above problem, an aqueous solution according to the present invention is an aqueous solution used for repairing an aluminum-coated steel wire with defects leading to there being iron, which contains magnesium chloride having a concentration of 10% or more, and magnesium sulfate having a concentration of 6% or more, and which allows an anticorrosion layer made of an alloy component of magnesium and aluminum to be formed.

In order to address the above problem, a repair method according to the present invention is a repair method for repairing an aluminum-coated steel wire with defects leading to there being iron, including: a step in which an aqueous solution containing magnesium chloride having a concentration of 10% or more and magnesium sulfate having a concentration of 6% or more is applied to the defects; a step in which the aluminum-coated steel wire to which the aqueous solution is applied is left for a predetermined time; and a step in which the aluminum-coated steel wire in which an anticorrosion layer is formed on a surface layer of iron and an iron corrosion product is washed.

### Effects of the Invention

According to the present invention, it is possible to easily repair an aluminum-coated steel wire with defects leading to there being iron at low cost.

### BRIEF DESCRIPTION OF DRAWINGS

FIG. 1 is a flowchart showing an example of a repair method according to the present embodiment.

FIG. 2A is a diagram for illustrating an example of the repair method according to the present embodiment.

FIG. 2B is a diagram for illustrating an example of the repair method according to the present embodiment.

FIG. 2C is a diagram for illustrating an example of the repair method according to the present embodiment.

FIG. 3 is a schematic view showing an example of results obtained by analyzing a sample simulating an aluminum-coated steel wire with defects leading to there being iron according to the present embodiment in a perforated part after exposing to an aqueous solution.

FIG. 4 is a diagram showing an example of the relationship between a diffraction angle and an intensity in an anticorrosion layer obtained by X-ray diffraction (XRD) measurement according to the present embodiment.

### DESCRIPTION OF EMBODIMENTS

One embodiment of the present invention will be described below in detail with reference to the drawings.

<Repair Method>

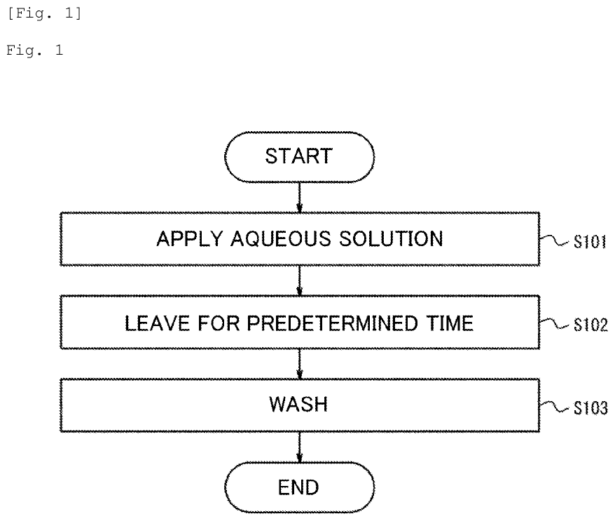

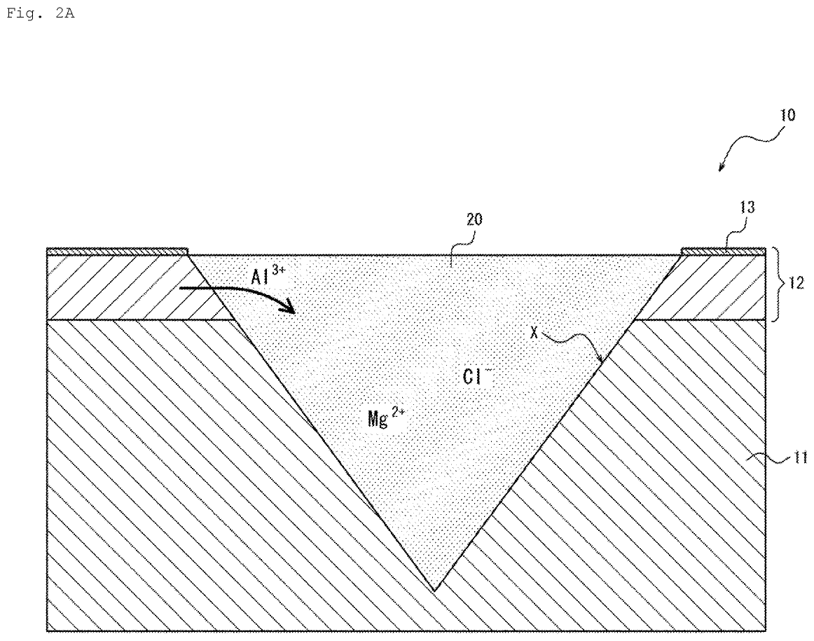

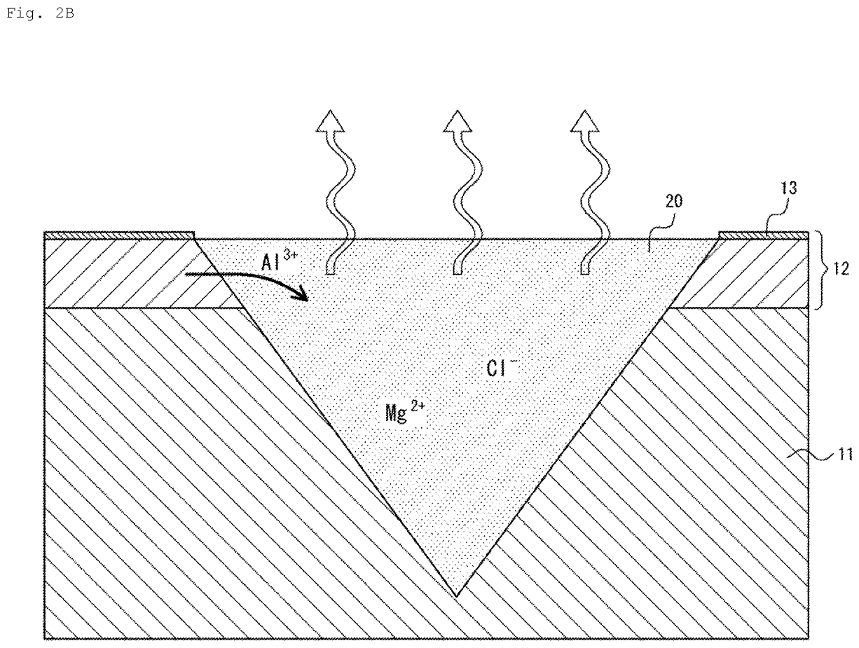

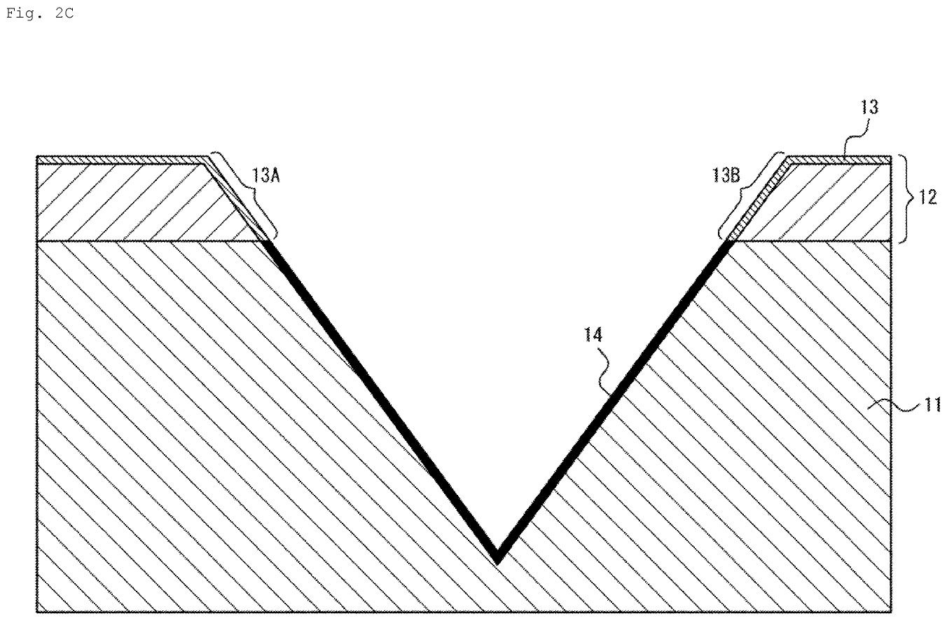

A repair method according to the present embodiment will be described with reference to FIG. 1 and FIG. 2A to FIG. 2C.

As shown in FIG. 1, the repair method according to the present embodiment is a repair method for repairing an aluminum-coated steel wire with defects leading to there being iron. The repair method includes a step (Step S101) in which an aqueous solution containing magnesium chloride (MgCl₂) having a concentration of 10% or more and a saturation concentration of 62% or less at a water temperature of 20° C. and magnesium sulfate (MgSO₄) having a concentration of 6% or more and a saturation concentration of 41% or less at a water temperature of 20° C. is applied to defects, a step (Step S102) in which an aluminum-coated steel wire to which an aqueous solution is applied is left for a predetermined time, and a step (Step S103) in which an aluminum-coated steel wire having an anticorrosion layer formed on a surface layer of iron and an iron corrosion product according to Step S101 and Step S102 is washed.

For details of “Safety data sheet” of magnesium chloride, for example, the following reference can be referred to.

“Safety data sheet”, product name: magnesium chloride, commercially available from Kanto Chemical Co., Inc.

For details of “Safety data sheet” of magnesium sulfate, for example, the following reference can be referred to.

“Safety data sheet”, product name: magnesium sulfate heptahydrate, commercially available from Kanto Chemical Co., Inc.

As shown in FIG. 2A, in Step S101, an operator applies an aqueous solution 20 to the defect X of an aluminum-coated steel wire 10 on which iron is exposed and an iron corrosion product is formed using, for example, a sprayer. The coating method is not particularly limited, and a known coating method can be applied.

The aqueous solution 20 contains magnesium chloride having a concentration of 10% or more and a saturation concentration of 62% or less at a water temperature of 20° C. and magnesium sulfate having a concentration of 6% or more and a saturation concentration of 41% or less at a water temperature of 20° C. When the concentration of magnesium chloride in the aqueous solution 20 is 10% or more, and the concentration of magnesium sulfate in the aqueous solution 20 is 6% or more, an anticorrosion layer 14 (refer to FIG. 2C) to be described below can be expressed on a surface layer of iron and an iron corrosion product. In addition, the aqueous solution 20 can express the anticorrosion layer 14 until the concentrations of magnesium chloride and magnesium sulfate reach a saturation concentration.

The aluminum-coated steel wire 10 includes a steel wire 11 mainly composed of iron (Fe) and a covering part 12 that covers the steel wire 11. The covering part 12 is mainly composed of aluminum (Al), and a coating 13 composed of aluminum oxide (Al(OH)₃) is formed on a surface layer of the aluminum.

As shown in FIG. 2B, in Step S102, the operator leaves the aluminum-coated steel wire 10 to which the aqueous solution 20 is applied for 12 hours or longer. The aqueous solution 20 is dried within 24 hours in an outdoor environment. Therefore, the time for which it is left is preferably 12 hours or longer.

When the aqueous solution 20 is applied to the defect X and left for 12 hours or longer, the anticorrosion layer 14 is formed on the surface layer of iron and an iron corrosion product. Specifically, first, aluminum ions (Al³⁺) are eluted from the aluminum-coated steel wire 10 (refer to the arrow in FIG. 2B). Then, with iron and the iron corrosion product serving as a catalyst, aluminum ions eluted from the aluminum-coated steel wire 10 and magnesium ions (Mg²⁺) present in the aqueous solution 20 bond to hydroxide ions (OH⁻) present in the aqueous solution 20. Thereby, the anticorrosion layer 14 composed of an alloy component of magnesium and aluminum (Mg₂Al(OH)₇) is formed on the surface layer of iron and the iron corrosion product (refer to FIG. 2C).

As shown in FIG. 2C, in Step S103, the operator washes the aluminum-coated steel wire 10 having the anticorrosion layer 14 formed on the surface layer of iron and the iron corrosion product with washing water containing no chloride ions (Cl⁻) and dries it. The reason why washing water containing no chloride ions is used is that there is a risk of chloride ions promoting pitting corrosion of the covering part 12.

When the operator performs a washing process using appropriately selected washing water, since chloride ions adhered to the covering part 12 can be completely removed, coatings 13A and 13B composed of aluminum oxide are newly formed on the surface layer of aluminum. Here, as described above, since the aqueous solution 20 is dried within 24 hours in an outdoor environment, it is recommended to wash the aluminum-coated steel wire 10 after 24 hours have elapsed.

When the above process is performed, in the aluminum-coated steel wire 10 with defects leading to there being iron X, the surface layer of iron and the iron corrosion product is coated with an anticorrosion coating having a high environment cutoff effect. That is, in the related art, since the corrosion product that should have been removed has an anticorrosion effect, an operation such as removal of the corrosion product is unnecessary, and the aluminum-coated steel wire 10 with the defects leading to there being iron X can be repaired.

Therefore, according to the repair method according to the present embodiment, since removal of the corrosion product is unnecessary, it is possible to easily repair an aluminum-coated steel wire with the defects leading to there being iron at low cost.

<Analysis Results>

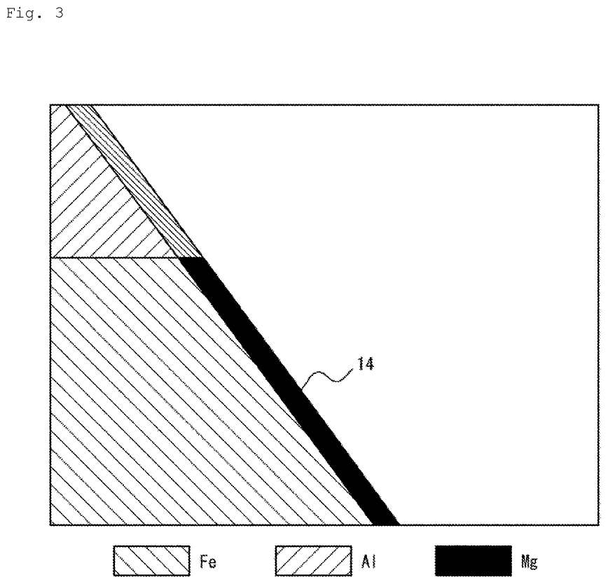

FIG. 3 is a schematic view showing an example of results obtained by analyzing a sample simulating an aluminum-coated steel wire with defects leading to there being iron in a perforated part after exposure to the aqueous solution 20.

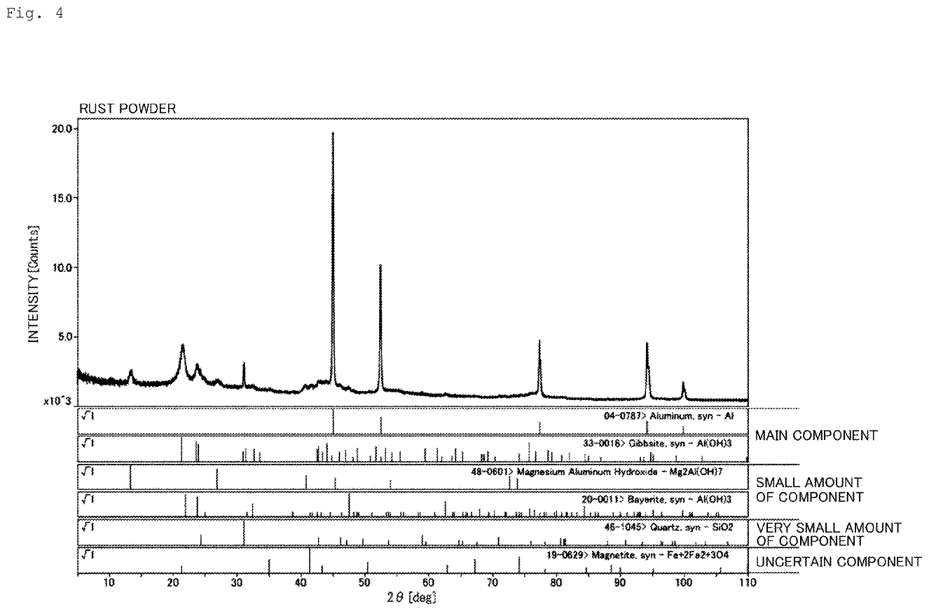

FIG. 4 is a diagram showing an example of the relationship between a diffraction angle and an intensity in the anticorrosion layer 14 obtained by XRD measurement. The horizontal axis represents diffraction angle 2θ[deg.]. The vertical axis represents intensity [Counts].

In FIG. 3, it can be understood that, when the sample is exposed to the aqueous solution 20 according to the present embodiment, the anticorrosion layer 14 containing magnesium as a main component is formed on the surface layer of iron and the iron corrosion product. In addition, from an XRD pattern shown in FIG. 4, the anticorrosion layer 14 can be identified as an alloy component of magnesium and aluminum (Mg₂Al(OH)₇).

Therefore, according to the repair method according to the present embodiment, since removal of the corrosion product is unnecessary, it is suggested that it is possible to easily repair an aluminum-coated steel wire with the defects leading to there being iron at low cost.

While the above embodiment has been described as a representative example, it will be apparent to those skilled in the art that many modifications and substitutions can be made within the spirit and scope of the present disclosure. Therefore, the present invention should not be interpreted as being restricted to the above embodiment, and various modifications and alternations can be made without departing from the scope of the claims. In addition, it is possible to combine a plurality of processes described in the flowchart of the embodiment into one process or divide single processes.

### REFERENCE SIGNS LIST

10 Aluminum-coated steel wire
11 Steel wire
12 Covering part
13 Coating
13A Coating
13B Coating
14 Anticorrosion layer
20 Aqueous solution

1. An aqueous solution used for repairing an aluminum-coated steel wire with defects leading to there being iron, which contains
magnesium chloride having a concentration of 10% or more, and
magnesium sulfate having a concentration of 6% or more, and
which allows an anticorrosion layer made of an alloy component of magnesium and aluminum to be formed.

2. The aqueous solution according to claim 1, wherein
the magnesium chloride has a saturation concentration of 62% or less at a water temperature of 20° C., and wherein
the magnesium sulfate has a saturation concentration of 41% or less at a water temperature of 20° C.

3. A method for repairing an aluminum-coated steel wire with defects leading to there being iron, comprising:
applying an aqueous solution containing magnesium chloride having a concentration of 10% or more and magnesium sulfate having a concentration of 6% or more to the defects;
leaving the aluminum-coated steel wire to which the aqueous solution is applied for a predetermined time; and
washing the aluminum-coated steel wire in which an anticorrosion layer is formed on a surface layer of iron and an iron corrosion product is washed.

4. The repair method according to claim 3, wherein
the magnesium chloride has a saturation concentration of 62% or less at a water temperature of 20° C., and wherein
the magnesium sulfate has a saturation concentration of 41% or less at a water temperature of 20° C.

5. The repair method according to claim 3, wherein
the predetermined time is 12 hours or longer.

6. The repair method according to claim 3, wherein
in the washing step, washing water containing no chloride ions is used.

7. The repair method according to claim 4, wherein
the predetermined time is 12 hours or longer.

8. The repair method according to claim 4, wherein
in the washing step, washing water containing no chloride ions is used.

9. The repair method according to claim 5, wherein
in the washing step, washing water containing no chloride ions is used.
